(19) United States
(12) Patent Application Publication
(10) Pub. No.: US 2017/0234770 A1
(43) Pub. Date: Aug. 17, 2017

(54) SOLENOID TESTING SYSTEM

(71) Applicant: Caterpillar Inc., Peoria, IL (US)

(72) Inventors: Daniel L. Nevarez, Nuevo Laredo (MX); Alberto F. Garcia Mortera, Nuevo Laredo (MX)

(73) Assignee: Caterpillar Inc., Peoria, IL (US)

(21) Appl. No.: 15/045,287

(22) Filed: Feb. 17, 2016

(51) Int. Cl. G01M 13/00; H01F 7/08

(52) U.S. Cl. CPC G01M 13/00; H01F 7/08

(57) ABSTRACT

A solenoid testing system for testing a solenoid is provided. The solenoid testing system includes a housing member having an inner surface and an outer surface. The solenoid is positioned on the outer surface. The solenoid testing system includes an armature adapted to move towards the solenoid upon generation of the magnetic field by the solenoid. The solenoid testing system includes at least one measuring device connected to the armature for measuring a value of a displacement parameter and a value of a load parameter associated with the armature. The solenoid testing system also includes a controller in communication with the measuring device. The controller is configured to determine an operational state of the solenoid, based on comparison of the value of the displacement parameter and the value of the load parameter with a first predefined set of values and a second predefined set of values, respectively.

### TECHNICAL FIELD

The present disclosure relates to testing of a solenoid, and more specifically relates to a method and a system for testing of a solenoid of a fuel injector of an engine.

### BACKGROUND

With the development of technology, electronic fuel injectors have replaced mechanical fuel injectors to improve efficiency and operational characteristics of internal combustion engines. An electronic fuel injector includes various components, such as a solenoid, an armature, and a needle valve. The solenoid is provided to generate a magnetic field when supplied with an electric current. The magnetic field generated by the solenoid actuates the armature that further lifts the needle valve for injecting pressurized fuel into a combustion chamber of an internal combustion engine.

However, in some cases, the solenoid of the fuel injector fails to generate a sufficient amount of magnetic field to actuate the armature. Consequently, the needle valve is not suitably lifted for injecting pressurized fuel into the combustion chamber. This leads to a failure of the internal combustion engine owing to the absence of fuel. In such circumstances, either the faulty fuel injector has to be replaced with a new fuel injector or the faulty fuel injector is uninstalled to replace a solenoid within the fuel injector. In either case, the fuel injector has to be uninstalled and reinstalled in the internal combustion engine. Such uninstallation and reinstallation would lead to inconvenience, an additional time to service, an increased machine downtime, and an increased maintenance cost.

WO Publication Number 2010/133423, hereinafter referred to as '423 application, discloses a method for measuring the armature lift in a fuel injector. The method includes inserting a measuring probe into the fuel injector such that the measuring probe comes in contact with the armature. The method includes actuating the fuel injector such that the armature carries out a lift movement. The method further includes measuring the lift movement by way of a measuring device that is operationally connected to the measuring probe. However, the method of the '423 publication is not accurate for testing a solenoid of the fuel injector.

### SUMMARY OF THE DISCLOSURE

In one aspect of the present disclosure, a solenoid testing system for testing a solenoid of a fuel injector of an engine is provided. The solenoid testing system includes a housing member having an inner surface and an outer surface. The solenoid is positioned on the outer surface of the housing member. The solenoid is adapted to generate a magnetic field, when supplied with an electric current from a power source. The solenoid testing system includes an armature movably disposed within the housing member. The armature has a first surface and a second surface distal to the first surface. The armature is so positioned underneath the solenoid that the first surface faces the inner surface of the housing member. The armature is adapted to move along a transverse axis towards the solenoid upon generation of the magnetic field by the solenoid. The solenoid testing system further includes at least one measuring device connected to the armature for measuring a value of a displacement parameter and a value of the load parameter associated with the armature. The value of the displacement parameter is indicative of a distance travelled by the armature along the transverse axis. The value of the load parameter is indicative of a force experienced by the armature while travelling the distance. The solenoid testing system also includes a controller in communication with the at least one measuring device. The controller is configured to receive the value of the displacement parameter and the value of the load parameter from the at least one measuring device. The controller is also configured to compare the value of the displacement parameter and the value of the load parameter with a first predefined set of values of the displacement parameter and a second predefined set of values of the load parameter, respectively. The controller is further configured to determine an operational state of the solenoid based on the comparison. The operational state includes at least one of a functional state and a non-functional state.

Other features and aspects of this disclosure will be apparent from the following description and the accompanying drawings.

### BRIEF DESCRIPTION OF THE DRAWINGS

FIG. 1 is a schematic view of a solenoid testing system for testing a solenoid of a fuel injector of an engine, according to one embodiment of the present disclosure;

FIG. 2 is a schematic view of the solenoid testing system of FIG. 1, when the solenoid is in an energized state; and

FIG. 3 is a flowchart of a method for testing the solenoid of the fuel injector of the engine.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

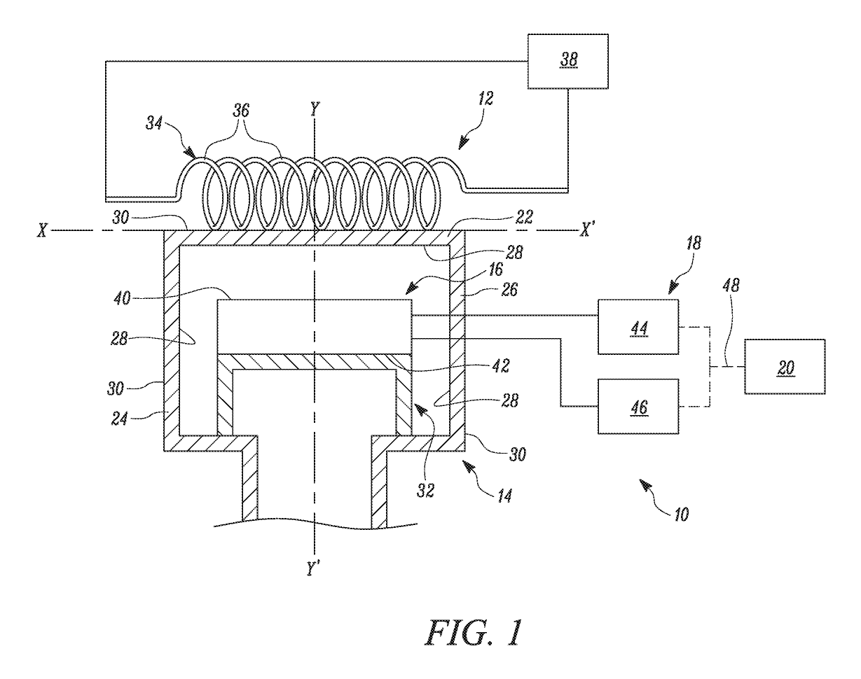

FIG. 1 is a schematic view of a solenoid testing system 10 for testing a solenoid 12 of a fuel injector (not shown) of an engine (not shown), according to one embodiment of the present disclosure. The solenoid testing system 10 includes a housing member 14, an armature 16 movably disposed within the housing member 14, at least one measuring device 18 connected to the armature 16, and a controller 20 in communication with the measuring device 18 for determining an operational state of the solenoid 12.

The housing member 14 includes a top wall 22, a first side wall 24, and a second side wall 26. The housing member 14 also includes an inner surface 28 and an outer surface 30 distal to the inner surface 28. The inner surface 28 and the outer surface 30 may be understood as the surfaces facing inside and outside of the housing member 14, respectively. The outer surface 30 of the housing member 14 supports the solenoid 12. In the present embodiment, the top wall 22 of the housing member 14 supports the solenoid 12. In one example, the housing member 14 may also include a support member 32 for supporting the armature 16 within the housing member 14.

The solenoid 12 is positioned on the outer surface 30 of the housing member 14. More specifically, the solenoid 12 is positioned along a horizontal axis XX′ of the housing member 14. The solenoid 12 is positioned with respect to the armature 16 in such a manner that the armature 16 lies within the magnetic field generated by the solenoid 12. The solenoid 12 includes a solenoid coil 34 having multiple windings 36. The solenoid coil 34 is tightly wound into a helix arrangement. The solenoid coil 34 may be made of copper, aluminum, steel, nickel, iron, or any other suitable metal or metallic-alloy known in the art.

The solenoid 12 is connected to a power source 38 for receiving an electric current. The power source 38 may include, but is not limited to, a generator, an alternator, a battery, a fuel cell, a transformer, and a power converter. The solenoid 12 is operated to generate a magnetic field, when supplied with the electric current from the power source 38. The solenoid 12 is configured to operate between an energized state and a de-energized state. The term “energized state” herein refers to an operational state in which the solenoid 12 generates the magnetic field, when supplied with the electric current from the power source 38. The term “de-energized state” herein refers to an operational state in which the solenoid 12 does not generate the magnetic field due to the absence of supply of the electric current from the power source 38.

The magnetic field generated by the solenoid 12 may vary based on factors including, but not limited to, the electric current supplied to the solenoid 12 and a number of windings 36 in the solenoid coil 34. It should be noted that the solenoid 12 with varying operational characteristics and dimensional characteristics can be tested by using the solenoid testing system 10. The operational characteristics may include, but are not limited to, electrical properties of the solenoid 12 and magnetic properties of the solenoid 12. The dimensional characteristics may include, but are not limited to, a length of the solenoid coil 34, the number of windings 36, and a type of solenoid coil arrangement.

The armature 16 is movably disposed within the housing member 14. The armature 16 is made of a soft magnetic material, such as steel. The armature 16 includes a first surface 40 and a second surface 42 distal to the first surface 40. The first surface 40 of the armature 16 faces the inner surface 28 of the housing member 14. More specifically, the first surface 40 of the armature 16 faces the top wall 22 of the housing member 14. In one example, the second surface 42 is connected to the measuring device 18. In another example, the second surface 42 is connected to a resilient means, e.g., a helical spring, (not shown) that assists in providing a resilient movement of the armature 16 under the influence of the magnetic field. In such an example, the measuring device 18 may be connected to the resilient means.

The armature 16 is movable along a transverse axis YY′ which is perpendicular to the horizontal axis XX′ of the housing member 14. More specifically, the armature 16 moves along the transverse axis YY′ towards the solenoid 12, upon generation of the magnetic field by the solenoid 12. It should be noted that the selection of the armature 16 to be used in the solenoid testing system 10 for testing the solenoid 12 may vary based on the operational characteristics and the dimensional characteristics of the solenoid 12 being tested.

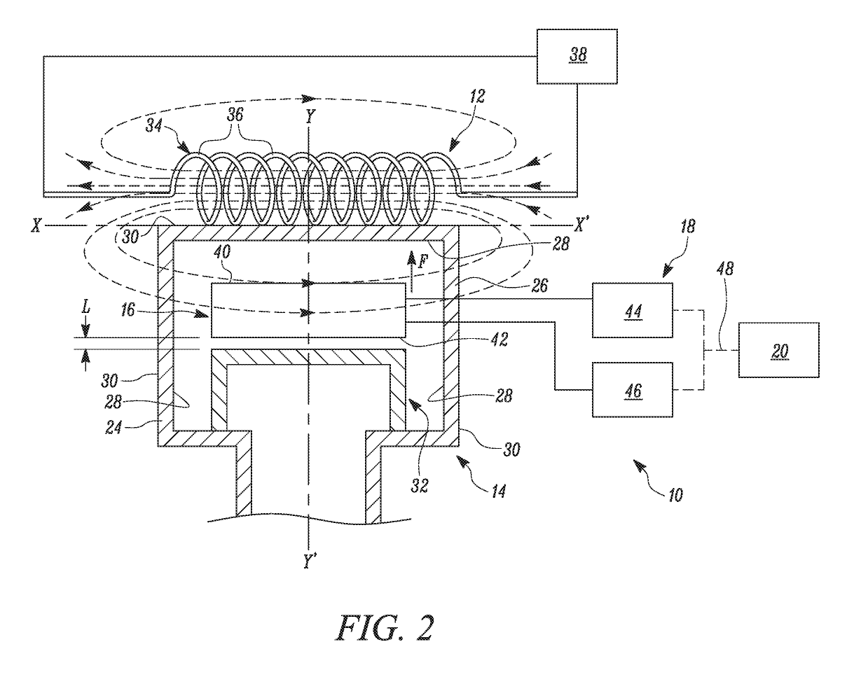

In present embodiment, the solenoid testing system 10 includes a pair of measuring devices 18. The measuring devices 18 include a first measuring device 44 and a second measuring device 46. The first measuring device 44 and the second measuring device 46 are connected to the armature 16 disposed within the housing member 14. The first measuring device 44 may include, but is not limited to, a position sensor, a proximity sensor, a measuring probe, a laser sensor, an inductive sensor, a capacitive displacement sensor, and a piezoelectric sensor. The first measuring device 44 is provided for measuring a value of a displacement parameter associated with the armature 16. The value of the displacement parameter is indicative of a distance ‘L’ (shown in FIG. 2) travelled by the armature 16 under the influence of the magnetic field generated by the solenoid 12.

The second measuring device 46 may include, but is not limited to, a load cell, a piezoelectric sensor, a force gauge, and a force sensor. The second measuring device 46 is provided for measuring a value of a load parameter associated with the armature 16. The value of the load parameter is indicative of a force ‘F’ experienced by the armature 16 while travelling the distance ‘L’. In one example, the force ‘F’ is an average force experienced by the armature 16 while travelling along the transverse axis YY′.

The measuring devices 18 are in communication with the controller 20 via a communication link 48. The controller 20 may include, but is not limited to, a microprocessor, a microcomputer, a digital signal processor, a central processing unit, a state machine, logic circuitries, or any devices that manipulate signals based on operational instructions. Further, the controller 20 may include an interface (not shown) to facilitate multiple communication within wide variety of protocols and networks, such as network, including wires or wireless network. Further, the interface may include one or more ports for connecting the controller 20 to a number of computing devices (not shown).

The controller 20 is configured to receive data from a data repository (not shown). The data repository stores data indicative of a first predefined set of values of the displacement parameter and a second predefined set of values of the load parameter. The first predefined set of values and the second predefined set of values include a range of values of the displacement parameter and the load parameter, respectively, defined for various operating states of the solenoid 12.

FIG. 2 illustrates a schematic view of the solenoid testing system 10 of FIG. 1, when the solenoid 12 is in the energized state. Referring to FIG. 1 and FIG. 2, when the electric current is supplied to the solenoid 12, the solenoid 12 generates the magnetic field that actuates the armature 16. Due to the magnetic field, the armature 16 begins to move along the transverse axis YY′ towards the solenoid 12 within the housing member 14. As shown in FIG. 2, the armature 16 experiences the force ‘F’ due to the magnetic field generated by the solenoid 12 in the energized state. Due to the force ‘F’, the armature 16 travels the distance ‘L’ along the transverse axis YY′ towards the solenoid 12.

Further, the first measuring device 44 measures the value of the displacement parameter associated with the armature 16. More specifically, the first measuring device 44 measures the distance ‘L’ travelled by the armature 16 under the influence of the magnetic field. The second measuring device 46 measures the value of the load parameter associated with the armature 16. More specifically, the second measuring device 46 measures the force ‘F’ experienced by the armature 16 under the influence of the magnetic field while travelling the distance ‘L’.

The controller 20 receives a first input and a second input from the first measuring device 44 and the second measuring device 46, respectively. The first input is indicative of the value of the displacement parameter. More specifically, the first input is indicative of the distance ‘L’ travelled by the armature 16 under the influence of the magnetic field. The second input is indicative of the value of the load parameter. More specifically, the second input is indicative of the force ‘F’ experienced by the armature 16 under the influence of the magnetic field.

Upon receiving the first input and the second input, the controller 20 compares the value of the displacement parameter and the value of the load parameter with the first predefined set of values and the second predefined set of values, respectively. Based on the comparison, the controller 20 determines the operational state of the solenoid 12. The operational state includes at least one of a functional state and a non-functional state. The term “functional state” herein refers to a working condition of the solenoid 12 which indicates that the solenoid 12 is suitable for being used in the fuel injector of the engine. The term “non-functional” state herein refers to the working condition of the solenoid 12 which indicates that the solenoid 12 is not suitable for being used in the fuel injector.

If the value of the displacement parameter and the value of the load parameter received from the measuring devices 18 are within the range of values of the first predefined set of values and the range of values of the second predefined set of values, respectively, then the controller 20 determines that the solenoid 12 is in the functional state. Further, if at least one of the value of the displacement parameter and the value of the load parameter received from the measuring devices 18 is outside the range of values of the first predefined set of values and the range of values of the second predefined set of values, respectively, then the controller 20 determines that the solenoid 12 is in the non-functional state.

In one example, the first predefined set of values may include a range of distance as 1-10 microns. Therefore, if the distance ‘L’ travelled by the armature 16 as detected by the first measuring device 44 falls within the range of 1-10 microns, the controller 20 may determine the operational state of the solenoid 12 as “functional state”. On the other hand, if the distance ‘L’ detected falls outside the range of 1-10 microns, the controller 20 may determine the operational state of the solenoid 12 as “non-functional state”.

In one example, the second predefined set of values may include a range of force as 62 Newton (N)-70 Newton (N). Therefore, if the force ‘F’ experienced by the armature 16 as detected by the second measuring device 46 falls within the range of 62 N-70 N, the controller 20 may determine the operational state of the solenoid 12 as “functional state”. On the other hand, if the force ‘F’ falls outside the range of 62 N-70 N, the controller 20 may determine the operational state of the solenoid 12 as “non-functional state”.

### INDUSTRIAL APPLICABILITY

The present disclosure relates to the solenoid testing system 10 for testing the solenoid 12 of the fuel injector of the engine. The solenoid testing system 10 includes the housing member 14, the armature 16 movably disposed within the housing member 14, the measuring devices 18 connected to the armature 16, and the controller 20 for determining the operational state of the solenoid 12. The solenoid 12 is positioned on the outer surface 30 of the housing member 14 with respect to the armature 16 in such a manner that the armature 16 lies within the magnetic filed generated by the solenoid 12.

The solenoid testing system 10 can be used for testing the solenoid 12 of the fuel injector that can be employed in any type of machine with a compression ignition internal combustion engine. Therefore, the solenoid testing system 10 has a wide range of application across industries. Further, the solenoid testing system 10 can be used for testing the solenoid 12 that can be employed in various applications, such as engines, industrial machineries, air conditioning systems, and solenoid valves. With respect to each application, dimensional characteristics and operational characteristics of the armature 16 may vary with respect to the dimensional characteristics and the operational characteristics of the solenoid 12 to be tested by using the solenoid testing system 10.

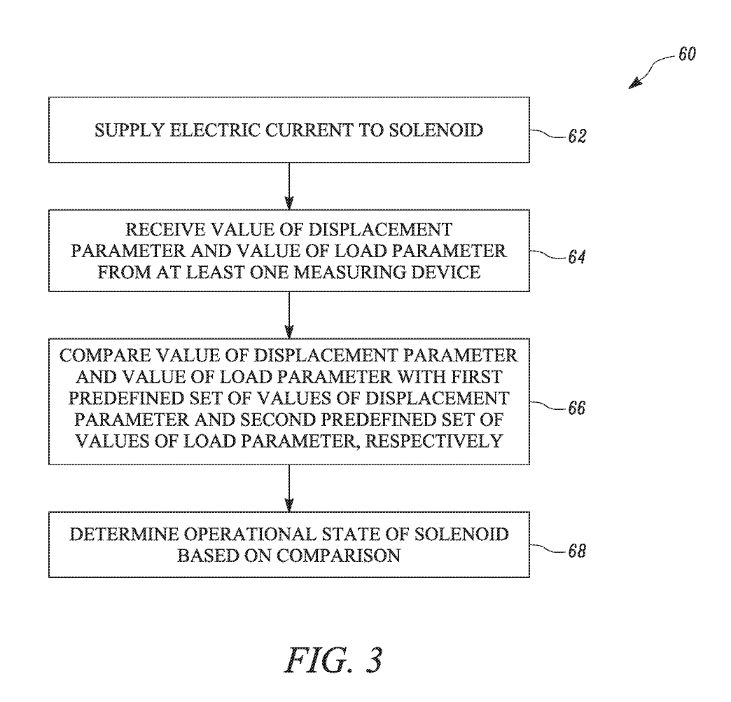

FIG. 3 is a flow chart depicting a method 60 for testing the solenoid 12 of the fuel injector, according to an embodiment of the present disclosure. For the sake of brevity, the elements of the present disclosure which are already explained in detail in previous sections are explained briefly in the description of FIG. 3. At step 62, the method 60 includes supplying the electric current to the solenoid 12 disposed on the outer surface 30 of the housing member 14.

At step 64, the method 60 includes receiving the value of the displacement parameter and the value of the load parameter from the measuring devices 18. Due to the magnetic field generated by the solenoid 12, the armature 16 experiences the force ‘F’ and therefore, travels the distance ‘L’ along the transverse axis YY′. The first measuring device 44 measures the value of the displacement parameter that is indicative of the distance ‘L’. The second measuring device 46 measures the value of the load parameter that is indicative of the force ‘F’. The controller 20 receives the first input and the second input from the measuring devices 18.

At step 66, the method 60 includes comparing the value of the displacement parameter and the value of the load parameter with the first predefined set of values of the displacement parameter and the second predefined set of values of the load parameter, respectively. At step 68, the method 60 includes determining the operational state of the solenoid 12 based on the comparison. The operational state includes at least one of the functional state and the non-functional state.

The solenoid testing system 10 and the method 60 of the present disclosure offer a simple, easy, and effective method for testing the solenoid 12 of the fuel injector of the engine. By using the solenoid testing system 10, the solenoid 12 of the fuel injector can be tested before deploying the solenoid 12 in the fuel injector of the engine. Therefore, the solenoid testing system 10 eliminates any inconvenience caused during a replacement procedure of the fuel injector, when the solenoid 12 of the fuel injector fails to operate effectively. As a result, the solenoid testing system 10 reduces machine downtime and maintenance cost as well.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. A solenoid testing system for testing a solenoid of a fuel injector of an engine, the system comprising:
a housing member having an inner surface and an outer surface;
the solenoid positioned on the outer surface of the housing member, wherein the solenoid is adapted to generate a magnetic field when supplied with an electric current from a power source;
an armature movably disposed within the housing member, the armature has a first surface and a second surface distal to the first surface, the armature is so positioned underneath the solenoid that the first surface faces the inner surface of the housing member, wherein the armature is adapted to move along a transverse axis towards the solenoid upon generation of the magnetic field by the solenoid;
at least one measuring device connected to the armature for measuring a value of a displacement parameter and a value of a load parameter associated with the armature, wherein the value of the displacement parameter is indicative of a distance travelled by the armature along the transverse axis, and the value of the load parameter is indicative of a force experienced by the armature while travelling the distance; and
a controller in communication with the at least one measuring device, the controller being configured to:
receive the value of the displacement parameter and the value of the load parameter from the at least one measuring device;
compare the value of the displacement parameter and the value of the load parameter with a first predefined set of values of the displacement parameter and a second predefined set of values of the load parameter, respectively; and
determine an operational state of the solenoid based on the comparison, wherein the operational state includes at least one of a functional state and a non-functional state.
